(19) United States
(12) Patent Application Publication
(10) Pub. No.: US 2024/0123544 A1
(43) Pub. Date: Apr. 18, 2024

(54) METHOD FOR MEDIA-IMPERMEABLE WELDING OF ALUMINUM-CONTAINING COMPONENTS

(71) Applicant: TRUMPF Laser- und Systemtechnik GmbH, Ditzingen (DE)

(72) Inventors: Philipp Scheible, Ditzingen/Heimerdingen (DE); Patrick Haug, Gerlingen (DE); Jan Wildermuth, Grossbottwar (DE)

(21) Appl. No.: 18/393,755

(22) Filed: Dec. 22, 2023

Related U.S. Application Data
(63) Continuation of application No. PCT/EP2022/066905, filed on Jun. 21, 2022.

(30) Foreign Application Priority Data
Jun. 23, 2021 (DE) 102021206486.8

(51) Int. Cl. B23K 26/067; B23K 26/06; B23K 26/064; B23K 26/073; B23K 26/244; B23K 26/26

(52) U.S. Cl. CPC B23K 26/0676; B23K 26/0626; B23K 26/064; B23K 26/0734; B23K 26/244; B23K 26/26; B23K 2103/10

(57) ABSTRACT

A method for welding at least two aluminum-containing components is provided. The components have an aluminum content of at least 75% by weight. The method includes subdividing an output laser beam into multiple partial beams directed onto the components, so that multiple laser spots are generated on a surface of the components, and traversing a welding contour on the surface of the components with the multiple laser spots. Laser spot centers of at least three laser spots of the multiple laser spots are arranged in a ring formation. The output laser beam is generated by a multifiber, so that each laser spot of the multiple laser spots on the surface of the components has a core portion and a ring portion, with a mean power density in the core portion being higher than a mean power density in the ring portion.

### CROSS REFERENCE TO RELATED APPLICATIONS

This application is a continuation of International Application No. PCT/EP2022/066905 (WO 2022/268824 A1), filed on Jun. 21, 2022, and claims benefit to German Patent Application No. DE 10 2021 206 486.8, filed on Jun. 23, 2021. The aforementioned applications are hereby incorporated by reference herein.

### FIELD

Embodiments of the present invention relate to a method for welding at least two aluminum-containing components.

### BACKGROUND

In the field of electromobility, for numerous usage situations it is necessary to join components which are impermeable to various media. Typical media with respect to which impermeability needs to be established are, for example, cooling liquids or protective gases, in order to provide a suitable atmosphere for sensitive elements.

In the field of electromobility, components based on aluminum materials are important, in particular due to the low specific weight. In order to join aluminum-containing components so that they are impermeable to media, up to now use has predominantly been made of soldering. During soldering, a solder needs to be fed in to create the soldered connection. Soldering is comparatively complex and difficult; in addition, soldered connections can be susceptible to corrosion. It is also possible to adhesively bond aluminum-containing components to one another in order to join them so that they are impermeable to media. Adhesive bonding is also comparatively complex and often requires lengthy curing processes, and the adhesive point can be sensitive to high temperatures.

Welding is a joining method which enables two workpieces to be permanently connected to one another. Laser welding is usually used if the intention is to carry out welding at a high welding speed, with a narrow and slender weld seam shape and with low thermal warpage. During laser welding, energy is fed in via a laser beam. To attain a high welding speed, the laser welding carried out is preferably deep penetration laser welding, a vapor capillary (keyhole) being formed in the component material.

The laser welding of media-impermeable weld seams in the case of aluminum components is, however, difficult. Aluminum-containing workpieces tend to cause strong turbulence in the melt pool during laser welding. This turbulence leads to non-uniform solidification of the weld seam. This can lead to seam collapses, edge notches or holes in the weld seam. The aforementioned problems in combination with cracks and pores at the weld seam can give rise to leaks at the weld seam, with the result that the welded components are not suitable for applications in which impermeability to media matters. Moreover, the strong turbulence in the melt pool during laser welding often results in formation of a considerable amount of welding spatter, which contaminates the surroundings and leads to a loss of material at the weld seam.

DE 10 2010 003 750 A1 discloses altering the beam profile characteristic of a laser beam by means of a multiclad fiber. Here, a laser beam having a core portion and a ring portion can be generated.

DE 10 2016 124 924 A1 discloses a laser welding apparatus which can be used to weld a seal plate on a housing body of a battery, the housing body and the seal plate being manufactured from aluminum. A collimated laser beam is conducted via a shaping device, which comprises a diffractive optical element (DOE) with an opening. The DOE can be used to subdivide an incident laser beam into multiple partial beams, for example into four partial beams, which are arranged corresponding to the corners of a square. Depending on the overlap of the collimated laser beam with the DOE or its opening, part of the collimated laser beam is subdivided into the partial beams by the DOE, or remains unshaped as it passes through the opening.

### SUMMARY

Embodiments of the present invention provide a method for welding at least two aluminum-containing components. The components have an aluminum content of at least 75% by weight. The method includes subdividing an output laser beam into multiple partial beams directed onto the components, so that multiple laser spots are generated on a surface of the components, and traversing a welding contour on the surface of the components with the multiple laser spots. Laser spot centers of at least three laser spots of the multiple laser spots are arranged in a ring formation. The output laser beam is generated by a multifiber, so that each laser spot of the multiple laser spots on the surface of the components has a core portion and a ring portion, with a mean power density in the core portion being higher than a mean power density in the ring portion.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a shows a schematic side view of an exemplary welding optical unit, with which the method according to embodiments of the invention can be carried out;

FIG. 1b shows the exemplary welding optical unit from FIG. 1a rotated by 90°, according to some embodiments;

FIG. 1c shows a schematic illustration of an exemplary 2-in-1 fiber in cross section according to some embodiments, as can be used as laser light cable in FIG. 1a and which makes it possible to provide an output laser beam for the method according to embodiments of the invention;

FIG. 2 shows the welding pattern of one variant of the method according to embodiments of the invention with four laser spots, as can be created by the exemplary welding optical unit of FIG. 1a;

FIG. 3 shows a schematic longitudinal section through two components during the welding operation with the welding pattern of FIG. 2, to elucidate the method according to embodiments of the invention;

FIG. 4 shows a schematic cross section through the vapor capillary of FIG. 3 in the planes A-A, B-B and C-C of that figure, according to some embodiments;

FIG. 5a shows the welding pattern of one variant of the method according to embodiments of the invention, in which the ring portions of four laser spots are arranged partially overlapping one another and touch one another at a middle point;

FIG. 5b shows a welding pattern of one variant of the method according to embodiments of the invention, in which the ring portions of three laser spots are arranged partially overlapping one another;

FIG. 5c shows a welding pattern of one variant of the method according to embodiments of the invention, in which the ring portions of five laser spots are arranged partially overlapping one another;

FIG. 6a shows a schematic plan view of an exemplary facet plate as can be used in a welding optical unit to generate multiple partial beams for the method according to embodiments of the invention;

FIG. 6b shows a schematic cross section through the exemplary facet plate of FIG. 6a according to some embodiments;

FIG. 6c shows a welding pattern of one variant of the method according to embodiments of the invention with six laser spots in a ring formation and one central laser spot, as can be created by the exemplary facet plate of FIG. 6a;

FIG. 7 shows an image, from an experiment, of a longitudinal microsection of two aluminum-containing components after carrying out the method according to embodiments of the invention.

### DETAILED DESCRIPTION

Embodiments of the invention provide a method for welding two aluminum-containing components which can be used to manufacture media-impermeable weld seams with high reliability.

According to some embodiments, an output laser beam is subdivided into multiple partial beams directed onto the components, such that multiple laser spots are generated on a surface of the components, the multiple laser spots traverse a welding contour on the surface of the components, and laser spot centers of at least three laser spots of the multiple laser spots are arranged in a ring formation. The output laser beam is generated by means of a multifiber, preferably a 2-in-1 fiber, with the result that the multiple laser spots on the surface of the components each have a core portion and a ring portion, with a mean power density in the core portion being higher than a mean power density in the ring portion.

For the welding of aluminum-containing components, embodiments of the invention include subdividing an output laser beam into multiple partial beams and correspondingly multiple laser spots on the workpiece surface. At least some of the laser spots (usually all laser spots or all laser spots except for one laser spot) are arranged on the workpiece surface in a ring formation. In addition, provision is made of beam shaping of the output laser beam using a multifiber, preferably a 2-in-1 fiber, which results in a respective subdivision of the laser power into a core portion with a higher power density and a ring portion with a lower power density in the output laser beam and in the partial beams, and thus in the individual laser spots (referred to as “2-in-1 technique” in the case of the 2-in-1 fiber). The multifiber comprises a central core fiber and one or more ring fibers which annularly surround the core fiber. The core portion results from the core fiber, and the ring portion results from the one or more ring fibers (if there are multiple ring fibers, the ring portion comprises multiple individual ring portions which then as a whole form the ring portion). By virtue of all of these measures, it is possible according to embodiments of the invention to achieve high-quality laser welding of aluminum-containing components and in particular to obtain a media-impermeable weld seam with few pores.

If an individual laser spot (single spot) is used, in the case of aluminum-containing components the 2-in-1 technique leads to a certain reduction in spatter formation compared to the single-spot technique with a conventional (unshaped) laser beam, but the remaining instabilities in the aluminum-containing components still have the effect that the weld seam obtained is generally not media-impermeable. Owing to the specific properties of the aluminum in the component material, strong turbulence continues to occur in the melt pool during the welding operation. In the case of an individual beam, the keyhole is possibly too small compared to the melt pool produced. In particular, many pores which then make the weld seam media-permeable are produced.

Surprisingly, however, the use of a multifiber or the 2-in-1 technique with multiple laser spots in a ring arrangement made it possible to obtain stable keyholes when laser welding aluminum-containing components. According to embodiments of the invention, it is possible to achieve larger keyholes (compared to individual keyholes in the case of individual laser spots); they are more stable and do not collapse. Instead, the melt can be displaced more reliably owing to the larger keyholes. A homogeneous solidification of the weld seam can be achieved.

The laser spot centers of the respective laser spots (that follow one another/are adjacent in the ring formation) of the ring formation can conceivably be connected to one another in the manner of a polygon which encloses an inner surface (polygon surface). The deep penetration welding according to embodiments of the invention in the aluminum-containing components can substantially take place in the region of this polygon surface.

The laser welding according to embodiments of the invention generates a large melt volume, in particular also preceding a respective vapor capillary (keyhole); in particular, those partial regions of the ring portions that are on the outside (with respect to the ring formation) can increase the melt volume. The laser spots can form a common melt in the process. The leading, large melt volume can reduce the dynamics of the melt and, as a result, turbulence.

According to embodiments of the invention, moreover, large keyholes can be established and the keyhole geometry changes (compared to a keyhole in the case of a single spot), and the absorption behavior of the laser radiation changes correspondingly. In particular, a common keyhole can be formed by all the laser spots or partial beams together. The melt can then flow around the respective vapor capillary as the welding process continues. Overall, a high keyhole stability can be achieved. High welding speeds with good seam quality are possible, and in particular media-impermeable weld seams of the aluminum-containing weld seams can be produced without problems, in particular with a lap joint.

The arrangement of at least three laser spots in a ring formation makes it possible to reduce the directional dependence of the welding process. With four or more laser spots in the ring formation, the welding process is already largely direction-independent (given a symmetrical arrangement of the laser spots). Moreover, the ring formation can stabilize a common keyhole of the aluminum-containing components very well. All of the laser spots on the workpiece surface are referred to as the weld pattern here.

The partial beams are typically generated by virtue of the output laser beam being conducted between a collimation optical unit and a focusing optical unit via one or more optical elements, which protrude at least into part of the beam cross section of the output laser beam. Typical optical elements for this are wedge plates; however, other diffractive and refractive optical elements can also be used. In a preferred variant, two bifocal inserts arranged at an angle of 90° to one another are used. It is similarly possible for the optical element used to be a facet plate, which has annularly arranged facets (outer facets) which correspond to the desired number of laser spots of the ring formation and are angled (inclined) at an angle β, typically where 0<β≤0.50°, often β≤0.25°, in relation to a base plane extending transversely to the beam propagation direction. The outer facets are typically at 360°/N in relation to one another, where N is the number of laser spots in the ring formation, and rotated in relation to one another about a central axis (optical axis of the facet plate, corresponding to the beam propagation direction). If a central laser spot is also desired, a further facet (central facet) which is parallel to the base plane may be provided, with the outer facets radially inwardly adjoining the central facet. The central facet is typically in the form of a regular polygon. If a central laser spot is not desired, the outer facets can radially inwardly simply abut one another at a common central point. A facet plate makes it possible to generate fundamentally any desired number of laser spots according to the configuration of the facet plate.

The laser spots are typically the same size. Typically, the laser spots of the ring formation are each allotted the same laser power. With respect to their laser spot centers, the laser spots of the ring formation typically have the same distance (radius) from a common center (centroid) of all of the laser spots.

The proportions of power for the core portion and the ring portion in the case of a respective laser spot can be set via the proportion of the output laser beam that is introduced into the core fiber and into the one or more ring fibers of the multifiber, respectively. Usually, the mean power density in the core portion is at least 2 times, often at least 4 times, that in the ring portion. The (outer) boundaries of the core portion and the ring portion can be determined as the location where the local power density is lower than half the mean power density in the core portion or the ring portion, in the case of multiple ring fibers in the outermost individual ring portion; in the case of an approximately uniform power density within the core portion and the ring portion, in the case of multiple ring fibers of the outermost individual ring portion, this meets a FWHM criterion. The diameters, or their ratio, of the core fiber and the (outermost) ring fiber at the imaged fiber end determine the diameters, or their ratio, respectively, of the core portion and the ring portion in a respective laser spot. The imaging ratio and thus the absolute size of the laser spots can be selected or set via the collimation optical unit and the focusing optical unit.

The welding contour is traversed continuously along its profile by the laser spot (without wobbling), typically at a constant advancement speed. This produces the (media-impermeable) weld seam. It should be noted that, when the welding contour is being traversed, the local advancement direction (welding direction), and as a result also the orientation of the weld pattern in relation to the local advancement direction, can change. Owing to the at least extensive directional independence according to embodiments of the invention of the weld pattern, such changes of the local advancement direction are largely non-critical in the case of the welding according to embodiments of the invention of the components.

The two aluminum-containing components to be welded may be arranged for example with a lap joint or a butt joint. The laser welding can be operated as partial penetration welding or as full penetration welding. Preferably, the aluminum-containing components are partial-penetration welded with a lap joint or a butt joint, and preferably are partial-penetration welded with a butt joint. It should be noted that the expression “components which are welded to one another according to embodiments of the present invention” is to be understood to mean locally with respect to the laser welding operation; correspondingly, the components to be welded can be separate before the laser welding or already be connected to one another independently of the connection to be welded.

The method according to an embodiment of the invention for welding aluminum-containing components provides for the at least two components to be welded to one another by partial penetration welding,
and for the laser welding that takes place
   to be partial penetration welding with a lap joint, in particular with the partial penetration welding taking place to at least 10% of a component thickness of a lower component of the lap joint, or
   to be partial penetration welding with a butt joint. Welding aluminum-containing components by partial penetration welding has proven successful in practice for the fabrication of media-impermeable weld seams.

The method according to an embodiment of the invention for welding aluminum-containing components provides for the at least two components to be welded to one another with a lap joint,
and for the laser welding that takes place
   to be partial penetration welding, with the partial penetration welding taking place to at least 10% of a component thickness of the lower component of the lap joint, or
   to be full penetration welding through all the components of the lap joint. Welding with a lap joint has proven successful in practice for fabricating media-impermeable weld seams, especially when the welding that takes place is partial penetration welding. The partial penetration welding makes it possible to establish a reliable seal by retaining solid material of the lower component.

A variant in which a common vapor capillary for all the laser spots is formed in the components and is surrounded by a common melt pool is preferred. The common vapor capillary is a continuous space in the components to be welded which contains metal vapor and is surrounded by liquid melt; the vapor capillaries of the individual laser spots (if they are used in isolation) combine to form this continuous space. The common vapor capillary (common keyhole) can be established by conducting the method in a suitable way, in particular with a distance between the laser spots of the ring formation that is not excessive. The common keyhole is considerably larger than a keyhole which could be created with an individual laser beam (single spot). The larger, and geometrically then also differently shaped, keyhole influences the absorption behavior of the incident laser radiation. Multiple intensity peaks, corresponding to the multiple laser spots of the ring formation, are distributed annularly around the common keyhole in a manner corresponding to the ring formation; in addition, an intensity peak of a further laser spot in the middle of the ring formation can also occur. A keyhole is stable at the location of a local intensity peak; the multiple intensity peaks at the common keyhole have the effect that the common, large keyhole is stabilized overall. By contrast, in the case of a single spot keyhole, only the region of a single intensity peak can be stabilized. The common vapor capillary protrudes (in the case of a lap weld) preferably deep enough that the cross section of the common vapor capillary also forms a continuous surface at an interface between the overlapping components to be welded. Furthermore, the common vapor capillary protrudes (generally) preferably deep enough that the common vapor capillary, in cross section, forms a continuous surface at the height of half the maximum depth of all the segments of the common vapor capillary. The cross section is assumed to be perpendicular to the beam propagation direction here.

A variant in which the multiple laser spots form an arrangement that has a rotational symmetry with an order corresponding to the number of laser spots of the ring formation is preferred. The rotational symmetry has the effect of high directional independence of the laser welding, that is to say the relative orientation of all of the laser spots in relation to the current advancement direction is of no, or only very little, importance for the welding process.

In one variant, it is provided that all the laser spots form the ring formation. This can be established easily, for example with two bifocal inserts in the case of four laser spots in the ring formation. In particular, no laser spot is provided in the middle of the ring formation here. If there are few laser spots in the ring formation (for example in the case of 3-5 laser spots in the ring formation), generally in this way a well-stabilized, common keyhole can be established.

In an alternative variant, a center of a laser spot is arranged in the middle of the ring formation. In other words, the laser spots of the ring formation are supplemented by a further laser spot arranged in the middle of the ring formation. This makes it possible to additionally stabilize a common keyhole, in particular if there are many laser spots in the ring formation (for example in the case of 4 or more, preferably 6 or more laser spots in the ring formation); in the case of many laser spots in the ring formation, usually a larger radius of the centers of the laser spots of the ring formation with respect to a common center of the laser spots is also selected, in order to reduce overlaps of the ring portions of the laser spots. In that case, the middle laser spot can stabilize the central region of the common keyhole and prevent a local recess in the keyhole in the central region.

In one variant, it is provided that
the ring formation is formed by exactly three laser spots,
in particular with the welding contour extending such that, during the laser welding and at least predominantly with respect to the local advancement direction,
   one laser spot of the ring formation is a leading laser spot and
   two laser spots of the ring formation are trailing laser spots having the same position with respect to the local advancement direction. With three laser spots in the ring formation, the directional dependence can already be considerably reduced in comparison with two (or even more) laser spots in a linear formation. The preferred primary alignment of the welding pattern in relation to the local welding direction/advancement direction with one leading and two trailing laser spots has proven successful in practice.

A variant in which the ring formation is formed by exactly four laser spots is preferred. This already makes it possible to easily bring about very extensive directional independence. The exactly four laser spots of the ring formation are preferably arranged in a square shape.

In a further development of this variant, the welding contour extends such that, during the laser welding, at least predominantly with respect to the local advancement direction,
one laser spot of the ring formation is a leading laser spot,
two laser spots of the ring formation are arranged in the middle with the same position with respect to the local advancement direction,
and one laser spot of the ring formation is a trailing laser spot. This predominantly applied orientation of the welding pattern (also referred to as “trapezium” arrangement) makes it possible to establish a comparatively wide weld seam with four laser spots in the ring formation and to obtain a large and stable melt pool.

Preference is given to a further development of this variant in which the welding contour extends such that, during the laser welding, at least predominantly with respect to the local advancement direction,
two laser spots of the ring formation are leading laser spots having the same position with respect to the local advancement direction,
and two laser spots of the ring formation are trailing laser spots having the same position with respect to the local advancement direction. This predominantly applied orientation of the welding pattern (also referred to as “square” arrangement) makes it possible to establish a comparatively narrow weld seam with four laser spots in the ring formation and as a result to cause deep melting with high welding speed and a stable melt pool. The predominant local welding direction/advancement direction can correspond to one of the main coordinate axes of the laser welding apparatus used. It should be noted that when cornering, the orientation of the welding pattern changes, for example from the square arrangement to the trapezium arrangement and back to the square arrangement again with passage through a 90° curve.

In another variant, the ring formation is formed by exactly five laser spots,
in particular with the welding contour extending such that, during the laser welding and at least predominantly with respect to the local advancement direction,
   one laser spot of the ring formation is a leading laser spot,
   two laser spots of the ring formation are arranged in the middle with the same position with respect to the local advancement direction,
   and two laser spots of the ring formation are trailing laser spots having the same position with respect to the local advancement direction. This variant has the effect of even better directional independence. With the one leading, the two middle and the two trailing laser spots in the preferably predominantly applied orientation of the welding pattern with respect to the advancement direction, a calm melt pool is obtained.

In another variant, the ring formation is formed by exactly six laser spots. In addition, another laser spot may be provided in the middle of the ring formation. This makes it possible to achieve even more extensive directional independence. It should be noted that a number of 3 to 6 laser spots in the ring formation is preferred according to an embodiment of the invention; a higher number generally entails only small improvements in terms of directional independence or melt pool stability.

According to some embodiments, the ring portions of laser spots that are adjacent in the ring formation are arranged touching one another. This makes it possible to achieve a very stable, common keyhole during the laser welding of the aluminum-containing components. The ring portions of adjacent laser spots of the ring formation are considered to touch one another when these laser spots have a distance between their laser spot centers that corresponds to the sum of half the respective diameter of their ring portions, with a tolerance of +/−10% with respect to this sum.

In an alternative variant, the ring portions of laser spots that are adjacent in the ring formation are arranged overlapping one another,
in particular with the core portions of laser spots of the ring formation not overlapping the ring portions of laser spots that are adjacent in the ring formation. The overlap of the ring portions of the laser spots, in particular without an overlap of ring portions and core portions, often makes it possible to reduce local projections and recesses of a common keyhole in relation to the depth in the components to be welded.

A further development of this variant in which, at any location, at most two ring portions of laser spots of the ring formation overlap one another is preferred. This has proven successful for a stable melt pool in the case of aluminum-containing components.

Also preferred is a further development in which the laser spots of the ring formation comprise a common center, where the ring portions of the laser spots of the ring formation touch one another,
in particular with exactly four laser spots being arranged in the ring formation. In this variant, which typically is configured without a laser spot in the middle of the ring formation, a calm and large keyhole with only small local projections and recesses in the depth of the components to be welded can be established.

Also advantageous is a variant in which the ring portions of all the laser spots of the ring formation overlap one another in a central region,
in particular with exactly three laser spots being arranged in the ring formation. In particular in the case of only a few laser spots, for instance three laser spots in the ring formation and without a further laser spot in the middle of the ring formation, the overlap of the ring portions of the laser spots of the ring arrangement in the central region makes it possible to generate an auxiliary intensity peak, which in addition to the intensity peaks of the core portions of the laser spots can stabilize a common keyhole.

In a preferred variant, it is provided that
for a diameter DK of the core portion and a diameter DR of the ring portion, it holds true that: 2≤DR/DK≤10, preferably 2.5≤DR/DK≤6, preferably 3.5≤DR/DK≤5,
and that, for a power proportion LK of the core portion in relation to the overall power in a respective laser spot, it holds true that: 10%≤LK≤90%, preferably 30%≤LK≤70%, preferably 40%≤LK≤60%. These parameter ranges have proven successful in practice in the case of aluminum-containing components for achieving a stable keyhole and media-impermeable weld seams.

Preference is also given to a variant which provides that
the components have a component thickness BD where 0.5 mm≤BD≤5.0 mm, and/or
the components are made from aluminum materials of the 3000, 5000 or 6000 series, and/or
the core portions of the laser spots have a diameter DK where 11 μm≤DK≤200 μm, preferably 50 μm≤DK≤150 μm, with diameters DK of up to 400 μm being conceivable, and the ring portions of the laser spots have a diameter DR where 50 μm≤DR≤700 μm, preferably 200 μm≤DR≤550 μm, with diameters DR of up to 1500 μm being conceivable, and/or
a mean laser power P of the output laser beam is applied where P≥2 kW, preferably P≥4 kW, and/or
a welding speed SG is applied where SG≥5 m/min, preferably SG≥10 m/min. These parameters have also proven successful in practice for laser welding aluminum-containing components.

A component arrangement produced by welding at least two components according to an above-described method according to embodiments of the invention is also provided,
the component arrangement being impermeable to a medium, in particular a cooling liquid, at the welded welding contour. By application of the method according to embodiments of the invention, the component arrangement can be easily and reliably manufactured with a weld seam (or welded welding contour) so as to be impermeable to media.

Further advantages of the embodiments of invention will emerge from the description and the drawing. Similarly, according to embodiments of the invention, the features mentioned above and those yet to be explained further may be used in each case individually or together in any desired combinations. The embodiments shown and described should not be understood as an exhaustive enumeration, but rather are of an exemplary character for outlining the invention.

Embodiments of the invention is illustrated in the drawing and explained in more detail on the basis of exemplary embodiments.

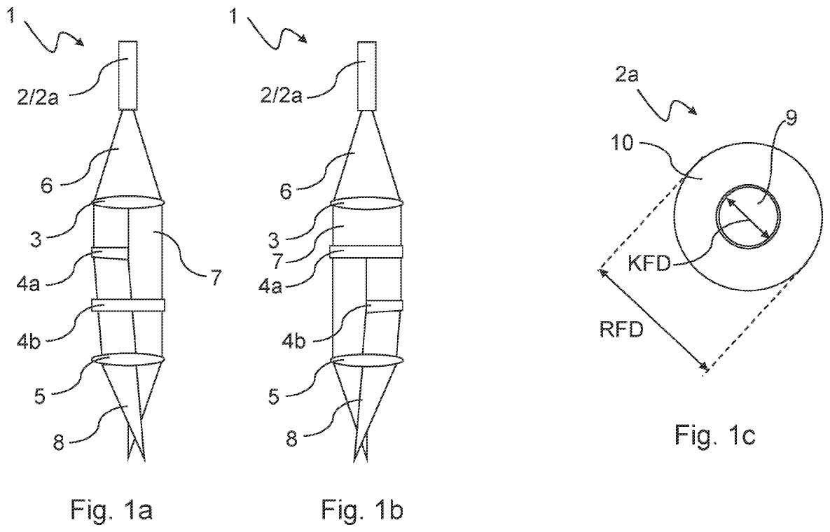

FIG. 1a shows a schematic side view of an exemplary welding optical unit 1, with which a preferred variant of the method according to the invention can be carried out. FIG. 1b shows the welding optical unit 1 of FIG. 1a rotated by 90°.

The welding optical unit 1 comprises a laser light cable 2, which is in the form of a multifiber, in this case a 2-in-1 fiber 2a, a collimation lens 3, two bifocal lens inserts 4a, 4b, which in this case are in the form of glass wedges, and a focusing lens 5. The bifocal inserts 4a, 4b are arranged one behind the other and are arranged rotated by 90° in relation to one another.

The laser light cable 2 is used to provide an output laser beam 6, which emerges at one fiber end of the laser light cable 2. The fiber end is in the focus of the collimation lens 3, and the output laser beam 6 is collimated by the collimation lens 3, as a result of which the output laser beam 6 becomes a collimated laser beam 7. The collimated laser beam 7 is guided to the bifocal inserts 4a, 4b. The bifocal inserts 4a, 4b in this instance take up approximately half of a cross section of the collimated laser beam 7. As a result, the collimated laser beam 7 is subdivided into four partial beams 8 in the exemplary welding optical unit 1 shown here. The partial beams 8 are focused by the focusing lens 5 onto a surface of a component (not illustrated) to be welded, as a result of which a welding pattern of in this case four laser spots of the same size is created on the surface of the component.

The selected mean laser power P of the output laser beam 6 can be for example P≥2 kW, preferably P≥4 kW.

FIG. 1c shows, by way of example, a cross section through the 2-in-1 fiber 2a, which makes it possible to provide the output laser beam for the method according to the invention.

The 2-in-1 fiber 2a comprises a core fiber 9 with a core fiber diameter KFD and a ring fiber 10 with a ring fiber diameter RFD. Typically, for the core fiber diameter KFD for example 11 μm≤KFD≤200 μm, preferably 50 μm≤KFD≤150 μm, can be selected and for the ring fiber diameter RFD for example 50 μm≤RFD≤700 μm, preferably 200 μm≤RFD≤550 μm can be selected. The imaging ratio of the welding optical unit (cf. FIG. 1a) which comprises the 2-in-1 fiber is selected to be 1:1 in the embodiment; in other embodiments, for example, an imaging ratio >1:1 can also be selected.

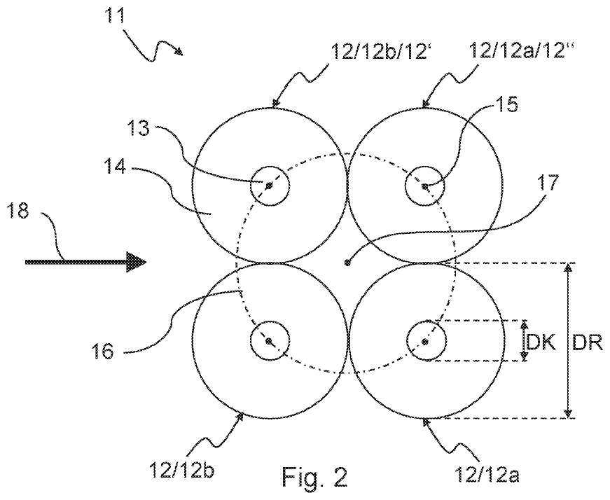

The 2-in-1 fiber makes it possible to generate a laser beam which has a core portion and a ring portion (see in this respect, for example FIG. 2 with respect to the laser spots) and serves as output laser beam in the welding optical unit (cf. FIG. 1a). To this end, an original laser beam (not shown in more detail) is fed partially into the core fiber 9 and partially into the ring fiber 10, for example through an optical wedge (not illustrated in more detail) pushed partially in the original laser beam.

FIG. 2 shows a schematic illustration of a welding pattern 11 on the surface of a component to be welded, as can be created by the exemplary welding optical unit of FIG. 1a.

The welding pattern 11 in this case comprises four laser spots 12 of the same size. The four laser spots 12 each have a core portion 13 and a ring portion 14, since the output laser beam is generated by the 2-in-1 fiber and accordingly for its part already has a core portion and a ring portion.

Each laser spot 14 has a laser spot center 15. The core portion 13 in this instance has a diameter DK of 100 μm and the ring portion 14 in this instance has a diameter DR of 400 μm. The ratio DR/DK is accordingly 4.

For a power proportion LK of the core portion 13 of an individual laser spot 12, LK=50% can be selected. In the variant shown here, the ring portion 14 has a surface area approximately 15 times that of the core portion 13. A mean power density in the core portion 13 in that case here is approximately 15 times greater than a mean power density in the ring portion 14.

The laser spots 12 are arranged in a ring formation 16; the laser spot centers 15 make it possible to define the corner points of a polygon (in this instance a square) which encloses an inner surface. The distance between two laser spot centers 15 of laser spots 12 that are adjacent in the ring formation 16 and next to one another (for example the laser spot centers 15 of the laser spots 12′ and 12″) is 400 μm in this case. In the variant shown here, the ring portions 14 of the laser spots 12 that are adjacent in the ring formation 16 touch one another exactly. The distance between the laser spot centers 15 of the laser spots 12 that are adjacent in the ring formation 16 corresponds to the sum of half the diameter DR of each of the ring portions 14 of the laser spots 12 involved.

The welding pattern 11 here has a fourfold rotational symmetry, since the ring formation 16 is formed by four laser spots 12 which can be transformed into one another by rotation about a common center (centroid) 17 by 90°. The laser spot centers 15 of the laser spots 12 of the ring formation 16 in this case lie on a circular line (illustrated in dashed line) around the common center 17.

With respect to a local advancement direction 18, the welding pattern 11 is arranged such that two laser spots 12a are leading laser spots and two laser spots 12b are trailing laser spots.

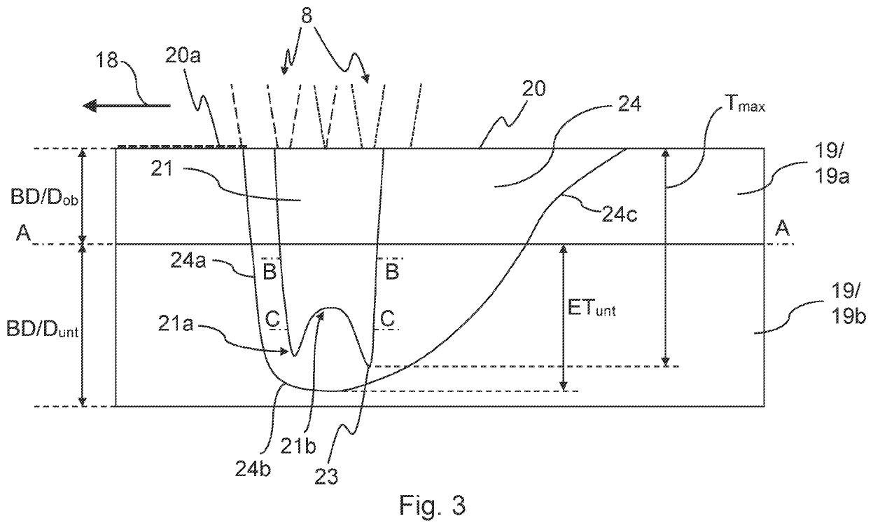

FIG. 3 shows a schematic longitudinal section through two components 19 during the welding operation with a welding pattern as illustrated in FIG. 2, to elucidate a preferred variant of the method according to the invention. The joining situation of the two components 19 is a lap joint. As an alternative, and not shown here, the joining situation of the two components 19 may also be a butt joint.

The components 19 are made from an aluminum material. An upper component 19a in this case has a component thickness BD or thickness D_{ob} of about 2 mm. A lower component 19b in this case has a component thickness BD or thickness Dᵤₙₜ of about 3 mm. The welding that takes place here is partial penetration welding. The longitudinal section is selected centrally through two laser spots that lie next to one another with respect to the advancement direction 18.

The partial beams 8 present in the longitudinal section of FIG. 3 are directed onto the surface 20 of the upper component 19a from the welding optical unit (not shown). The partial beams 8 penetrate the components 19 from the surface 20 and evaporate the aluminum material in their immediate surroundings. The action of all the partial beams 8 or all the laser spots causes a common vapor capillary 21 to form (also referred to as common keyhole or common metal vapor capillary), which extends into the lower component 19b. The common vapor capillary 21 forms a continuous volume in the components 19. In the regions close to the core portions of the partial beams 8, the common vapor capillary 21 has deeper segments 21a (“projections”). In a region between the partial beams 8, the common vapor capillary 21 has a shallower segment 21b (“recess”). A maximum depth Tₘₐₓ of the common vapor capillary 21 at a lowest point 23 in this instance is approximately 4 mm.

The combination of the 2-in-1 technique with multiple laser spots created by the partial beams 8 makes the common vapor capillary 21 stable.

In the surroundings of the common vapor capillary 21, the aluminum material is melted, as a result of which a melt pool 24 of liquid aluminum material forms. Since, during the welding operation, the partial beams 8 are moved relative to the components 19 in the advancement direction 18 along a welding contour 20a, in the illustration shown here toward the left, the melt pool 24 sags toward the right. At a left-hand edge 24a and at a lower edge 24b of the melt pool 24 aluminum material is melted, while at a right-hand edge 24c of the melt pool 24 aluminum material resolidifies.

The partial penetration welding in the lower component 19b takes place to a welding depth ETᵤₙₜ, which in the case shown is approximately 85% of the component thickness Dᵤₙₜ. In this way, a good and media-impermeable welded connection can be obtained. In a variant which is not shown, it is similarly possible for the laser welding performed to be full penetration welding through all the components 19 of the lap joint.

The selected aluminum materials for the components 19 can be materials of the 3000, 5000 or 6000 series. A selected welding speed SG can be SG≥5 m/min, preferably SG≥10 m/min.

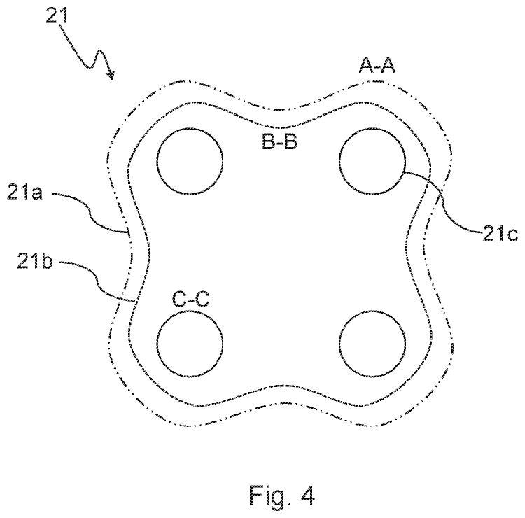

FIG. 4 shows schematic cross sections through the vapor capillary 21 of FIG. 3 in the planes A-A, B-B and C-C of that figure.

The dash-dotted line shows an outline 21a of the vapor capillary 21 in the plane A-A of FIG. 3, which lies in the interface of the upper and lower components, that is to say at a depth of approximately 2 mm. The vapor capillary 21 forms a continuous surface in this case.

The dashed line shows an outline 21b of the vapor capillary 21 in the plane B-B of FIG. 3, which in terms of depth corresponds to half the maximum depth Tₘₐₓ of the common vapor capillary, which in this instance is approximately 2.5 mm deep. In this instance the vapor capillary 21 forms a somewhat smaller but still continuous surface.

An outline 21c of the vapor capillary 21 approximately 3.8 mm deep in the vapor capillary 21 in the plane C-C of FIG. 3 is shown with a continuous line. In cross section at this depth, the vapor capillary forms four separate (non-cohesive) partial regions which are each approximately circular. Plane C-C thus intersects the vapor capillary only in the region of the local projections.

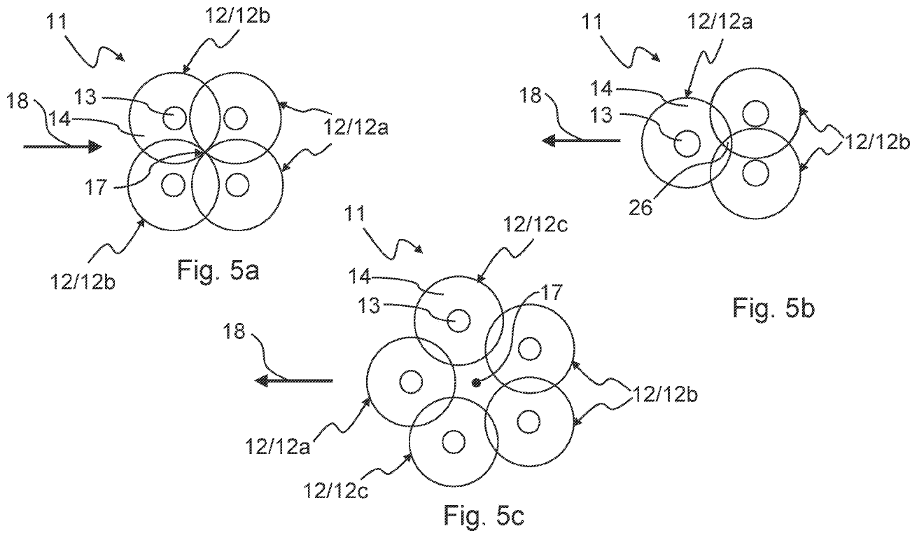

FIG. 5a shows a schematic illustration of a welding pattern 11 in cross section with four laser spots 12 in a ring formation, for another variant of the invention.

Here, the laser spots 12 are all the same size. The core portion 13 in this instance has a diameter DK of 100 μm and the ring portion 14 in this instance has a diameter DR of 400 μm. The ratio DR/DK is accordingly 4.

The distance between two (diagonally) opposite centers of the laser spots 12 is 400 μm in this instance. In the variant shown here, the ring portions 14 of the opposite laser spots 12 touch one another exactly in the common center 17. The adjacent laser spots 12 are arranged overlapping one another. The core portions 13 do not overlap. The welding pattern 11 here has a fourfold rotational symmetry, since the ring formation is formed by four laser spots 12 which can be transformed into one another by rotation about the common center 17 by 90°.

With respect to the local advancement direction 18 depicted, the welding pattern 11 is arranged such that the two laser spots 12a are leading laser spots and the two laser spots 12b are trailing laser spots. The two laser spots 12a are at identical positions with respect to the local advancement direction 18. Similarly, the two laser spots 12b are at identical positions with respect to the local advancement direction 18.

FIG. 5b shows a schematic illustration of a welding pattern 11 in cross section with three laser spots 12 in a ring formation, in another variant of the invention.

Here, the laser spots 12 are all the same size. The core portion 13 in this instance has a diameter DK of 300 μm and the ring portion 14 in this instance has a diameter DR of 800 μm. The ratio DR/DK is accordingly 2.67.

The adjacent laser spots 12 are arranged overlapping one another with respect to the ring portions 14 and all three laser spots 12 overlap in the ring portions 14 in a central region 26. The core portions 13 do not overlap.

With respect to the local advancement direction 18 shown, the welding pattern 11 is arranged such that one laser spot 12a is a leading laser spot and two laser spots 12b are trailing laser spots. The two laser spots 12b are at identical positions with respect to the local advancement direction 18. In this case, the laser spots 12b are spaced apart from one another to a somewhat smaller extent than the leading laser spot 12a is from each of the trailing laser spots 12b (with respect to the laser spot centers in each case).

FIG. 5c shows a schematic illustration of a welding pattern 11 in cross section with five laser spots 12 in a ring formation, in another variant of the invention.

Here, the laser spots 12 are all the same size. The core portion 13 in this instance has a diameter DK of 100 μm and the ring portion 14 in this instance has a diameter DR of 400 μm. The ratio DR/DK is accordingly 4.

The distance between two laser spot centers 15 the laser spots 12 that are adjacent in the ring formation is approximately 350 μm in this instance. In the variant shown here, the laser spots 12 that are adjacent in the ring formation are arranged overlapping one another by way of the ring portions 14. The welding pattern 11 here has a fivefold rotational symmetry, since the ring formation is formed by five laser spots 12 which can be transformed into one another by rotation about the common center 17 by 72°.

With respect to the local advancement direction 18 shown, the welding pattern 11 is arranged such that one laser spot 12a is a leading laser spot, two laser spots 12b are trailing laser spots, and two laser spots 12c are arranged in the middle between the laser spots 12a, 12b. The two trailing laser spots 12b are at identical positions with respect to the local advancement direction 18. Similarly, the two middle laser spots 12c are at identical positions with respect to the local advancement direction 18.

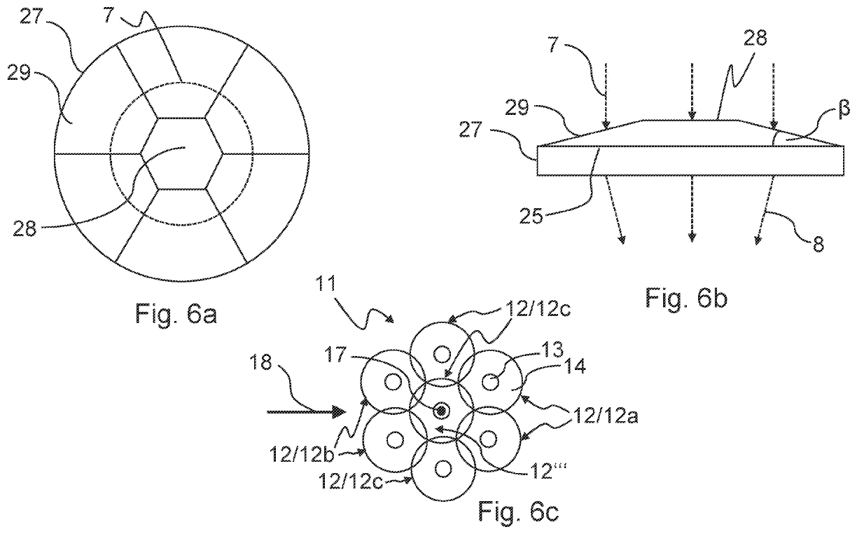

FIG. 6a shows a schematic plan view of an exemplary facet plate 27 as can be used in a welding optical unit to generate multiple partial beams for the method according to the invention.

In the form shown here, the facet plate 27 comprises a regularly hexagonal central facet 28 (“central facet”). The facet plate 27 comprises six outer facets 29 (“outer facets”) arranged around it. The collimated laser beam 7 is incident on the facet plate 27.

FIG. 6b shows a schematic cross section through the exemplary facet plate 27 of FIG. 6a.

The outer facets 29 have a wedge-shaped form. A facet angle 3 in this instance is approximately 0.15°, measured with respect to a base plane 25 which is perpendicular to the direction of incidence of the collimated laser beam 7. The collimated laser beam 7 is incident on the facet plate 27. In the region of the central facet 28, there is no deflection of the collimated laser beam 7. In the regions of the six outer facets 29, the collimated laser beam 7 is deflected (refracted). The result is therefore one undeflected partial beam 8 and six deflected partial beams 8.

FIG. 6c shows a welding pattern 11 of one variant of the method according to the invention with six laser spots 12 in a ring formation and one central laser spot 12, as can be created by the exemplary facet plate 27 of FIG. 6a. The central laser spot 12 is also denoted 12′″ here.

Here, the laser spots 12 are all the same size. The core portion 13 in this instance has a diameter DK of 100 μm and the ring portion 14 in this instance has a diameter DR of 400 μm. The ratio DR/DK is accordingly 4.

The distance between two laser spot centers 15 the laser spots 12 that are adjacent in the ring formation is approximately 350 μm in this instance. In the variant shown here, the laser spots 12 that are adjacent in the ring formation are arranged overlapping one another by way of the ring portions 14. The central laser spot 12′″ is arranged overlapping all the other laser spots 12 by way of the ring portions 14. The core portions 13 do not overlap. The welding pattern 11 in this instance has a sixfold rotational symmetry, since the ring formation is formed by six laser spots 12 which can be transformed into one another by rotation about the common center 17 by 60°; the central laser spot 12′″ remains untouched by the rotation, since its laser spot center coincides with the common center 17.

With respect to the local advancement direction 18, the welding pattern 11 is arranged such that the two laser spots 12a are leading laser spots, the two laser spots 12b are trailing laser spots, and the three laser spots 12c are arranged in the middle between the laser spots 12a, 12b.

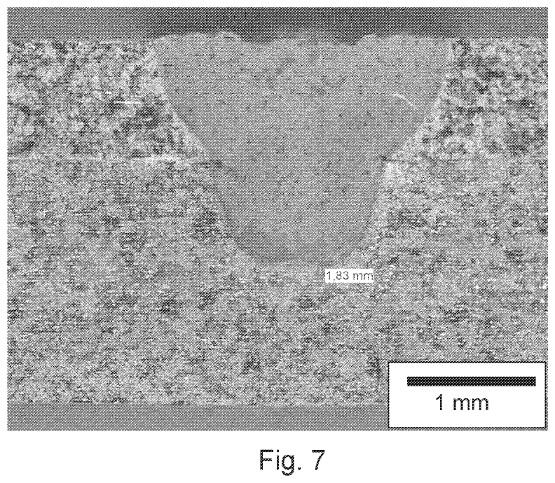

FIG. 7 shows an image, from an experiment, of two aluminum-containing components which are welded to one another with a lap joint when one variant of the method according to the invention is carried out. A transverse microsection is made and photographed in an optical microscope.

The upper component has a component thickness of approximately 1 mm, and the lower component has a component thickness of approximately 2 mm. The welding took place by partial penetration welding in the bottom component to approximately 40%; the welding direction was perpendicular to the plane of the drawing. A virtually pore-free, media-impermeable weld seam was obtained.

In the present example, the welding pattern of FIG. 2 (see above) was applied, with four laser spots in a square arrangement touching one another. An (overall) mean laser power P=3 kW and a welding speed SG=5 m/min were selected. The power proportion in the core was 70%, the core diameter DK was 100 μm, and the ring diameter DR was 400 μm for each laser spot. The aluminum-containing components were made from the aluminum alloy AW-5083.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Welding optical unit
2 Laser light cable
2a 2-in-1 fiber
3 Collimation lens
4a, 4b Bifocal inserts
5 Focusing lens
6 Output laser beam
7 Collimated laser beam
8 Partial beam
9 Core fiber
10 Ring fiber
11 Weld pattern
12 Laser spot
12′ Laser spot adjacent to laser spot 12″
12″ Laser spot adjacent to laser spot 12′
12′″ Central laser spot
12a Leading laser spot
12b Trailing laser spot
12c Middle laser spot
13 Core portion
14 Ring portion
15 Laser spot center
16 Ring formation
17 Common center
18 Advancement direction
19 Component
19a Upper component
19b Lower component
20 Surface
20a Welding contour
21 Vapor capillary
21a Projection
21b Recess
23 Lowest point
24 Melt pool
24a Left-hand edge
24b Lower edge
24c Right-hand edge
25 Base plane
26 Central region
27 Facet plate
28 Central facet
29 Outer facets
β Facet angle
BD Component thickness
DK Diameter of core portion
D_{ob} Component thickness of upper component
DR Diameter of ring portion
Dᵤₙₜ Component thickness of lower component
ETᵤₙₜ Weld depth into the bottom component
KFD Core fiber diameter
RFD Ring fiber diameter
Tₘₐₓ Maximum depth of the vapor capillary

1. A method for welding at least two aluminum-containing components, the components each having an aluminum content of at least 75% by weight, the method comprising:
subdividing an output laser beam into multiple partial beams directed onto the components, so that multiple laser spots are generated on a surface of the components, and
traversing a welding contour on the surface of the components with the multiple laser spots,
wherein laser spot centers of at least three laser spots of the multiple laser spots are arranged in a ring formation,
wherein the output laser beam is generated by a multifiber, so that each laser spot of the multiple laser spots on the surface of the components has a core portion and a ring portion, with a mean power density in the core portion being higher than a mean power density in the ring portion.

2. The method as claimed in claim 1, wherein the multifiber comprises a 2-in-1 fiber.

3. The method as claimed in claim 1, wherein
the at least two components are welded to one another by partial penetration welding with a lap joint, and
the partial penetration welding takes place to at least 10% of a component thickness of a lower component of the lap joint.

4. The method as claimed in claim 1, wherein the at least two components are welded to one another by partial penetration welding with a butt joint.

5. The method as claimed in claim 1, wherein a common vapor capillary of all of the multiple laser spots surrounded by a common melt pool is formed in the components.

6. The method as claimed in claim 1, wherein the multiple laser spots form an arrangement that exhibits rotational symmetry with an order corresponding to a number of laser spots of the ring formation.

7. The method as claimed in claim 1, wherein the ring formation is formed by exactly four laser spots.

8. The method as claimed in claim 7, wherein the welding contour extends such that, during the laser welding and at least predominantly with respect to a local advancement direction,
two laser spots of the ring formation are leading laser spots having a first same position with respect to the local advancement direction,
and two other laser spots of the ring formation are trailing laser spots having a second same position with respect to the local advancement direction.

9. The method as claimed in claim 1, wherein the ring formation is formed by exactly five laser spots,
wherein the welding contour extends such that, during the laser welding and at least predominantly with respect to a local advancement direction,
one laser spot of the ring formation is a leading laser spot,
two laser spots of the ring formation are arranged in a middle with a first same position with respect to the local advancement direction,
and two other laser spots of the ring formation are trailing laser spots having a second same position with respect to the local advancement direction.

10. The method as claimed in claim 1, wherein the ring portions of the laser spots that are adjacent in the ring formation are arranged touching one another.

11. The method as claimed in claim 1, wherein
the ring portions of the laser spots that are adjacent in the ring formation are arranged overlapping one another,
with the core portions of the laser spots of the ring formation not overlapping with the ring portions of the laser spots that are adjacent in the ring formation.

12. The method as claimed in claim 11, wherein, at any location, at most two ring portions of the laser spots of the ring formation overlap one another.

13. The method as claimed in claim 11, wherein the laser spots of the ring formation comprise a common center, at which the ring portions of the laser spots of the ring formation touch one another, with exactly four laser spots being arranged in the ring formation.

14. The method as claimed in claim 1, wherein, in a central region, the ring portions of all the laser spots of the ring formation overlap one another, with exactly three laser spots being arranged in the ring formation.

15. The method as claimed in claim 1, wherein
for a diameter DK of the core portion and a diameter DR of the ring portion, it holds true that: 2≤DR/DK≤10,
and wherein, for a power proportion LK of the core portion in relation to an overall power in a respective laser spot, it holds true that: 10%≤LK≤90%.

16. The method as claimed in claim 15, wherein it holds true that 2.5≤DR/DK≤6, and 30%≤LK≤70%.

17. The method as claimed in claim 15, wherein it holds true that 3.5≤DR/DK≤5, and 40%≤LK≤60%.

18. The method as claimed in claim 1, wherein
the components have a component thickness BD, where 0.5 mm≤BD≤5.0 mm, and/or
the components are made from aluminum materials of the 3000, 5000 or 6000 series, and/or
the core portions of the laser spots have a diameter DK, where 11 μm≤DK≤200 μm, and the ring portions of the laser spots have a diameter DR, where 50 μm≤DR≤700 μm.

19. The method as claimed in claim 1, wherein a mean laser power P of the output laser beam is applied, where P≥2 kW, and/or
a welding speed SG is applied, where SG≥5 m/min.

20. A component arrangement produced by welding at least two components by a method as claimed in claim 1,
the component arrangement being impermeable to a cooling liquid, at the welded welding contour.
